(19) United States
(12) Patent Application Publication
(10) Pub. No.: US 2019/0173623 A1
(43) Pub. Date: Jun. 6, 2019

(54) REALLOCATION OF CONTROL CHANNEL RESOURCES FOR RETRANSMISSION OF DATA IN WIRELESS NETWORKS BASED ON COMMUNICATIONS MODE

(71) Applicant: NOKIA SOLUTIONS AND NETWORKS OY, Espoo (FI)

(72) Inventors: Saeed Reza Khosravirad, Wroclaw (PL); Klaus Ingemann Pedersen, Aalborg (DK)

(21) Appl. No.: 16/309,881

(22) PCT Filed: Jun. 15, 2016
(86) PCT No.: PCT/EP2016/063749

§ 371 Date: Dec. 14, 2018

(51) Int. Cl. H04L 1/18; H04L 7/00; H04L 5/00; H04W 72/04; H04B 17/336

(52) U.S. Cl. CPC H04L 1/1819; H04L 1/1896; H04B 17/336; H04L 5/0055; H04W 72/0406; H04L 7/0016

(57) ABSTRACT

A technique is provided for allocating resources based on a communications mode. The technique may include receiving, by a user device from a base station in a wireless network, information indicating a communications mode to be used to receive a data retransmission, and receiving, by the user device based on the communications mode, a data retransmission that includes control information and retransmitted data, wherein a portion of resources allocated for the control information is based on the communications mode.

### TECHNICAL FIELD

This description relates to communications, and in particular, to a use of one of a plurality of communications modes for a retransmission of data in a wireless network, and also to a reallocation of control channel resources for retransmission of data based on a communications mode.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

Many modern communication systems, including LTE, employ a combination of forward error correction coding and ARQ (automatic repeat request), known as hybrid automatic repeat request (HARQ). HARQ uses forward error correction (FEC) codes to correct a subset of errors and relies on error detection to detect uncorrectable errors. Erroneously received packets may be stored to be combined with other transmissions, and the receiver requests a retransmission of the corrupted packet(s) by sending a negative acknowledgement (NACK) to the transmitter. This is a combination of FEC and ARQ. A version of the original packet (a version of the data/payload in the original packet) is then retransmitted, and the receiver may combine multiple received versions of the packet/payload. The receiver may also send an acknowledgement (ACK) for correctly received (decoded) packets. HARQ feedback may include either an ACK or a NACK.

5G wireless networks may also use HARQ to provide for retransmission for lost or erroneously received packets or codewords.

### SUMMARY

According to an example implementation, a method may include receiving, by a user device from a base station in a wireless network, information indicating a communications mode to be used to receive a data retransmission; and receiving, by the user device based on the communications mode, a data retransmission that includes control information and retransmitted data, wherein a portion of resources allocated for the control information is based on the communications mode.

According to an example implementation, an apparatus includes at least one processor and at least one memory including computer instructions, when executed by the at least one processor, cause the apparatus to: receive, by a user device from a base station in a wireless network, information indicating a communications mode to be used to receive a data retransmission; and receive, by the user device based on the communications mode, a data retransmission that includes control information and retransmitted data, wherein a portion of resources allocated for the control information is based on the communications mode.

According to an example implementation, an apparatus includes means for receiving, by a user device from a base station in a wireless network, information indicating a communications mode to be used to receive a data retransmission; and means for receiving, by the user device based on the communications mode, a data retransmission that includes control information and retransmitted data, wherein a portion of resources allocated for the control information is based on the communications mode.

According to an example implementation, a computer program product includes a computer-readable storage medium and storing executable code that, when executed by at least one data processing apparatus, is configured to cause the at least one data processing apparatus to perform a method including: receiving, by a user device from a base station in a wireless network, information indicating a communications mode to be used to receive a data retransmission; and receiving, by the user device based on the communications mode, a data retransmission that includes control information and retransmitted data, wherein a portion of resources allocated for the control information is based on the communications mode.

According to an example implementation, a method may include transmitting, by a base station in a wireless network, information indicating a communications mode to be used to transmit a data retransmission; and transmitting, by the base station based on the communications mode, a data retransmission that includes control information and retransmitted data, wherein a portion of resources allocated for the control information is based on the communications mode.

According to an example implementation, an apparatus includes at least one processor and at least one memory including computer instructions, when executed by the at least one processor, cause the apparatus to: transmit, by a base station in a wireless network, information indicating a communications mode to be used to transmit a data retransmission; and transmit, by the base station based on the communications mode, a data retransmission that includes control information and retransmitted data, wherein a portion of resources allocated for the control information is based on the communications mode.

According to an example implementation, an apparatus includes means for transmitting, by a base station in a wireless network, information indicating a communications mode to be used to transmit a data retransmission; and means for transmitting, by the base station based on the communications mode, a data retransmission that includes control information and retransmitted data, wherein a portion of resources allocated for the control information is based on the communications mode.

According to an example implementation, a computer program product includes a computer-readable storage medium and storing executable code that, when executed by at least one data processing apparatus, is configured to cause the at least one data processing apparatus to perform a method including: transmitting, by a base station in a wireless network, information indicating a communications mode to be used to transmit a data retransmission; and transmitting, by the base station based on the communications mode, a data retransmission that includes control information and retransmitted data, wherein a portion of resources allocated for the control information is based on the communications mode.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating an initial transmission and a plurality of retransmissions for different communications modes according to an example implementation.

FIG. 3 is a diagram illustrating a re-allocation of control information resources for a retransmission according to example implementations.

FIG. 4 is a flow chart illustrating operation of a base station according to an example implementation.

FIG. 5 is a flow chart illustrating operation of a user device (UE) according to an example implementation.

FIG. 6 is a flow chart illustrating operation of a user device according to an example implementation.

FIG. 7 is a flow chart illustrating operation of a base station according to an example implementation.

FIG. 8 is a block diagram of a node or wireless station (e.g., base station/access point or mobile station/user device/UE) according to an example implementation.

### DETAILED DESCRIPTION

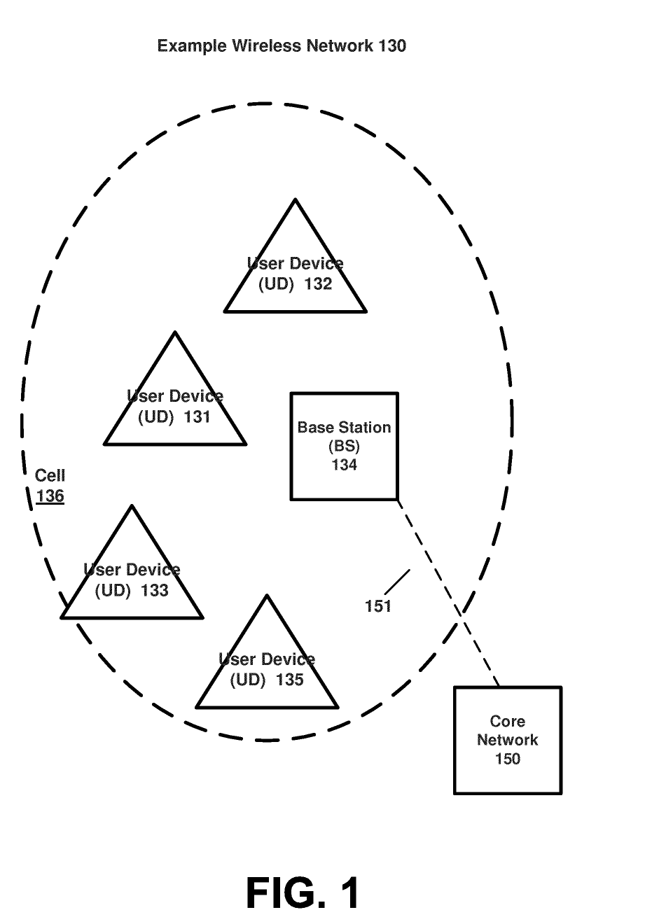

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB) or a network node. At least part of the functionalities of an access point (AP), base station (BS) or (e)Node B (eNB) may also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples, or any other wireless device. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, LTE-A Pro, 5G, cmWave, and/or mmWave band networks, or any other wireless network. LTE, 5G, cmWave and mmWave band networks are provided only as illustrative examples, and the various example implementations may be applied to any wireless technology/wireless network.

According to an example implementation, the wireless network in FIG. 1 may employ a combination of forward error correction coding and ARQ (automatic repeat request), referred to as hybrid ARQ (HARQ). With such an approach, for example for data transmission in the downlink direction, BS 134 (as an example transmitter) may transmit a packet or data block to user device 132, for example. User device 132 (as an example receiver) may use forward error correction (FEC) codes to correct errors in the received data block, where possible. User device 132 may use error detection to detect uncorrectable errors. If the received data block cannot be decoded by user device 132 due to errors, user device 132 may send a negative acknowledgement (NACK) for the packet to the BS 134. In response to receiving the NACK, BS 134 may resend (retransmit) the data block or packet payload or a redundancy version of the data block to the user device 132. User device 132 may combine multiple received versions of the data block to decode the data block, which may sometimes be referred to as soft combining, by way of illustrative example. One or more retransmissions of data may be a different redundancy version of the data, for example. User device 132 may then send an acknowledgement (ACK) for the packet to BS 134 to acknowledge that the data block was received and decoded. A similar process may be followed for uplink data transmission, where the user device 132 may send data to the BS 134. The ACK/NACK feedback may be referred to as HARQ feedback.

According to an example implementation, a flexible approach for resource allocation may be provided in which control information (or a control channel/CCH) and data (or a data channel) may be multiplexed over a set of resources. In some cases, this may be referred to as in-resource CCH (control channel) signaling, e.g., in which control information and data are multiplexed over a set of (e.g., shared) resources. According to an example implementation, for a transmission or a retransmission of data, different hybrid ARQ (HARQ) communications modes may be used. For example, a BS may select a first communications mode for an initial transmission of data, and then may select a second communications mode for a data retransmission, e.g., depending on a traffic type, an aggregation level, and/or other parameter. Each communications mode may have a different or varying amount of control information overhead, e.g., for transmission of a packet or codeword. Control information overhead may vary from user device to user device. For example, link adaptation may be used for the control channel, meaning that more resources are used for the control channel for user devices with poor SINR (signal to interference plus noise ratio), as compared to user devices having good SINR conditions.

According to an example implementation, a communications mode-dependent allocation of resources may be provided for a transmission/retransmission of a packet, codeword, block of data, etc. Therefore, by way of illustrative example, rather than using a fixed allocation of resources for data and a fixed allocation of resources for control information, a more flexible approach to resource allocation may be used in which a variable or flexible amount of resources may be allocated for the control information (CCH) and/or data for a transmission/retransmission, depending on the amount of resources required for control information/CCH for a communications mode that is used to transmit/retransmit data. For example, for a communications mode that requires less control information (lower control information/CCH overhead), this may free up or make available some control information resources (resources that may have been allocated to control information), but which are now available (not used to transmit control information) and may be reallocated for another purpose (e.g., for the transmission of other information). For a given transmission (which may include control information and data), the resources may be allocated and/or reallocated between control information, data, and possibly other purposes (e.g., such as for transmission of other data to the user device or for the transmission of control information or data to another user device) based on the varying control information overhead of the communications mode that is used for the transmission/retransmission.

Control channel (CCH) signaling in wireless/radio communications may, for example, be used to communicate control information, such as the attributes of a data transmission (e.g., modulation, coding rate, HARQ information, transmission resource allocation, etc.), and to provide other control information. According to an example implementation, a flexible approach may be used in which CCH (control channel/control information) and data may be multiplexed over the same resources (set of shared resourced). According to an example implementation, in-resource CCH signaling may be used for 5G wireless networks to provide a flexible approach to resource allocation. It assumes that the CCH and the corresponding data will be multiplexed over the allocated resources (which will enhance the transmission through less processing delay and using the advantages of beamforming over both CCH and data). The in-resource CCH may also enable multiplexing multiple users/user devices over the radio interface with a significantly lower average CCH overhead. The size of the CCH in the in-resource CCH concept may vary or be different according to the aggregation level used for a user device or transmission given its channel quality. Aggregation level may indicate a repetition encoding for control information/control channel information (CCH), e.g., indicating a number of times a control information/CCH is repeated or included within a packet or transmission. Thus, for example, aggregation level may refer to repetition coding for control information/CCH. For example, Aggregation level 2 may indicate the control information is included twice, while aggregation level 4 may indicate that control information is included four times, etc. Different aggregation levels may be used, e.g., based on a channel quality (SINR) for a channel between a user device and a base station (e.g., higher aggregation level may be used for a lower channel quality). In this regard, depending on a channel quality experienced or measured by a user device, repetition encoding (aggregation level) of 2, 4, or 8 can be applied over the CCH. Therefore, depending on the experienced signal to interference noise ratio (SINR) for a target block error rate (BLER) of 1% the following set of CCH overhead sizes may be used, by way of example.

TABLE 1
Examples of CCH overhead size for different aggregation levels.

| | |
|---|---|
| SINR level | CCH overhead size |

| | | |
|---|---|---|
| −5 | dB | (8 × 36=) 288 REs |
| −2.2 | dB | (4 × 36=) 144 REs |
| 0.2 | dB | (2 × 36=) 72 REs |
| 4.2 | dB | (1 × 36=) 36 REs |

Various example implementations may relate to efficient use of radio/wireless resources. According to an example implementation, one or more of the example implementations may relate to an efficient use of resources, such as, for example, a scenario where in-resource CCH signaling is used (e.g., control information and data are multiplexed on a set of resources), where the amount of resources allocated for control information (or CCH) depends on (or may vary based on) a communications mode (e.g., HARQ communications mode) used to transmit/receive a packet or codeword. A user device may have one or more HARQ processes. For example, a user device may have multiple (or a plurality of) HARQ processes for uplink communication and multiple HARQ processes for downlink communications.

According to an example implementation, a number of different communications modes (e.g., HARQ communications modes, e.g., to be used for retransmission, which may also be referred to as HARQ process types) may be used to transmit (or retransmit) and receive data. A HARQ communications mode (or HARQ process type), for example, may define one or more attributes or characteristics of a retransmission, such as whether the retransmission will be synchronous or asynchronous, adaptive or non-adaptive, etc. Some example HARQ communications modes are described as illustrative examples as follows:

1) Adaptive HARQ communications mode, wherein, for example, one or more (or all) of a group of transmission attributes may change or vary for a HARQ process, such as the MCS (modulation and coding scheme), frequency transmission resource allocation, etc.

2) Non-Adaptive HARQ communications mode, e.g., wherein the (one or more or all of the) transmission attributes (e.g., MCS, frequency resources or physical resource blocks used for transmission) remain fixed for a HARQ process. Thus, a non-adaptive HARQ communications mode may typically have lower control information overhead as compared to adaptive HARQ communications mode. This is because, e.g., one or more transmission parameters may change over time for a HARQ process for adaptive HARQ communications mode, while one or more of these transmission parameters may remain the same (remain unchanged) for a HARQ process in a non-adaptive HARQ communications mode, and thus, there is no need to continue indicating or specifying each of the transmission attributes after these attributes have been communicated a first time. Thus, for example, fewer resources are typically required for control information/CCH for non-adaptive HARQ communications mode, as compared to adaptive HARQ communications mode.

3) Asynchronous HARQ communications mode, wherein a timing (or location/subframe) of a transmission/retransmission may change or may vary. For example, in asynchronous HARQ, a HARQ process ID may typically be specified/included in each (or one or more) transmission/retransmission so that the user device can match a HARQ process for each transmission/retransmission. Thus, because the timing or location of a transmission or retransmission may vary for asynchronous HARQ communications mode, a HARQ process ID is included to identify the HARQ process ID for a transmission/retransmission.

4) Synchronous HARQ communications mode, wherein a timing (or subframe/location) for a HARQ retransmission will remain fixed during the HARQ process and therefore the CCH message (control information) regarding the transmission setup will only need to be signaled once to the user device along with or before the initial transmission of the data/packet. A timing for a retransmission may be specified (e.g., an offset 4 subframes) that may indicate the timing or location of a data retransmission after an initial transmission of the data. For example, a timing or offset of 4 subframes or TTIs (transmission time intervals) would indicate that a retransmission would be transmitted 4 subframes after an initial transmission. Thus, a synchronous HARQ communications mode will typically have lower control information (CCH) overhead (because the timing or offset for a retransmission is fixed for the HARQ process) as compared to asynchronous HARQ communications mode, e.g., because a timing or location of a transmission/retransmission may be fixed. Thus, for example, bits or control information resources may be saved (and made available for other purposes) for the synchronous HARQ communications mode because, for example, it is not necessary to transmit a HARQ process ID with each transmission/retransmission (once the timing or offset is provided for a HARQ process ID), since the transmission/retransmission will occur at the indicated timing or offset. In other words, for synchronous HARQ communications mode, the HARQ process for a transmission/retransmission may be identified by the user device based on the timing (e.g., which subframe) the transmission/retransmission occurs, and hence, it is not necessary for the BS to include a HARQ process ID with each transmission/retransmission once this timing/offset is provided to the user device for the HARQ process. Therefore, for example, fewer resources are typically required for control information/CCH for synchronous HARQ communications mode, as compared to non-synchronous HARQ communications mode.

Also, various communications modes may be combined, such as, for example:

5) Asynchronous and adaptive (asynchronous/adaptive) HARQ communications mode, that combines both asynchronous HARQ (e.g., wherein a HARQ process ID is included to identify the HARQ process for a transmission/retransmission) and adaptive HARQ (e.g., wherein transmission attributes within a HARQ process may vary, and thus, may be indicated for a transmission/retransmission).

6) Synchronous and non-adaptive (synchronous/non-adaptive) HARQ communications mode that combines both synchronous HARQ (e.g., where a HARQ process ID may be omitted due to a fixed timing or offset or fixed location of a transmission or retransmission) and non-adaptive HARQ (e.g., where one or more transmission attributes (such as, for example, MCS, frequency resources or physical resource blocks used for transmission) remain fixed for a HARQ process). Note that the specific fields, attributes or parameters that may be omitted for synchronous and/or non-adaptive HARQ communications modes are provided by way of example, and other fields, parameters or attributes may be omitted for these HARQ communications modes.

7) Synchronous and robust HARQ communications mode that combines a synchronous HARQ communications mode with a robust communications mode. Robust HARQ communications mode may involve using any available (or freed up) control information (or CCH) resources, e.g., bits, physical resource blocks (PRBs) or other resources that may have been freed up or made available for another use/purpose, to transmit additional code bits or parity bits for the transmitted data/retransmitted data (transmitted to the user device via the data resources of the transmission), and thereby decrease the code rate for such data. Thus, the robust communications mode (by using the available control information/CCH resources to transmit additional code bits or parity bits for the transmitted data) may improve the likelihood that the user device will be able to decode the transmitted/retransmitted data. According to an example implementation, the synchronous/robust HARQ communications mode may be considered as a class or type of synchronous/non-adaptive HARQ communications mode.

According to an example implementation, a combination of asynchronous and adaptive HARQ communications modes may use the most control information/CCH resources, whereas a combination of synchronous/non-adaptive HARQ communications mode may use the least/fewest control information/CCH resources. The other HARQ communications modes may use or require an amount of control information/CCH resources that may be in between these two, e.g., the other HARQ communications modes may typically use/require less control information/CCH resources than the asynchronous/adaptive communications mode and may use more control information/CCH resources than the synchronous/non-adaptive HARQ communications mode.

Therefore, according to various example implementations, techniques are provided to allocate control information/CCH resources, e.g., in a scenario where control channel (CCH) and data channel are multiplexed over a set of (e.g., a set of the same) resources. The control information/CCH overhead size from one transmission to another transmission (or retransmission) of a HARQ process may vary, e.g., may increase or may decrease. For example, the control information/CCH overhead for a transmission/retransmission may vary based on a HARQ communications mode that is used for the transmission/retransmission, since different communications modes may include different CCH overhead. According to an example implementation, the CCH may be expected to be lower in a case of synchronous HARQ communications mode and/or non-Adaptive HARQ communications mode. Thus, for example, the use of a synchronous and/or non-adaptive HARQ communications modes (e.g., as compared to asynchronous and/or adaptive HARQ communications modes) may typically free up (or make available) some of the CCH resources in the allocated resources for the HARQ process. The freed-up (or made available) resources may be used for several different options, such as, for example: 1) to transmit more parity/code bits for the same data packet/data transmission transmitted to the user device, and thereby decrease the coding rate and, as a result, increase the likelihood of the user device being able to decode the received data; 2) to multiplex (or include within the transmission resources) new data for the same user device; or 3) to multiplex data and/or control information/CCH transmitted to another user device.

Various example implementations may include a number of features and/or advantages, such as, for example:

1) A technique for control channel signaling may be provided, e.g., for a BS to inform a user device of a HARQ communications mode that the user device should be using or following to receive a data transmission/retransmission. Some different communications modes that may be used may include, for example: asynchronous HARQ communications mode, synchronous HARQ communications mode, adaptive HARQ communications mode, non-adaptive HARQ communications mode, and/or some various combinations of communications modes, such as asynchronous and adaptive HARQ communications mode, synchronous and adaptive HARQ communications mode, synchronous and robust HARQ communications mode, synchronous and non-adaptive HARQ communications mode, etc.

As noted, some of the different HARQ communications modes may have different control information/CCH overhead. As a result, it may be inefficient (e.g., a waste of resources, at least in some cases) to allocate the same (or a fixed) amount of control information/CCH resources for each transmission, e.g., because some of the communications modes may require fewer control information/CCH resources. Therefore, according to an example implementation, by using a more flexible resource allocation, control information/CCH resources may be freed up or made available for other purposes, at least for some HARQ communications modes. For example, control information/CCH resources may be freed up or made available when using one or more lower control information/CCH overhead communications modes (e.g., by way of example, synchronous and/or non-adaptive communications modes) to transmit/retransmit data, as compared to the use of one or more of the higher control information/CCH overhead communications modes (e.g., by way of example, asynchronous and/or adaptive communications modes).

2) Techniques may be provided to signal or communicate, within an initial data transmission, a timing of a synchronous HARQ communications mode used for a retransmission of data. For example, a timing of a data retransmission for a synchronous communications mode may be communicated or indicated within control information of an initial data. Thus, the timing for a retransmission of data for a synchronous communications mode may be provided as a fixed number e.g. T=8 where T is the number of TTIs (transmission time intervals) or subframes (e.g., 8 subframes) from the initial transmission to the retransmission. Alternatively the timing (e.g., T) may be fixed, based on one or more criteria or parameters for a user device or HARQ process, such as a different or specific timing for data retransmission for synchronous communications mode for each of a plurality of different traffic types, e.g., a first synchronous timing (T1) for data retransmission of a traffic type of URLLC (ultra reliable low latency communication), a second synchronous timing (T2) for eMBB (enhanced molbile broadband) traffic type, a third synchronous timing (T3) for mMTC (massive machine type communication), etc. Thus, in example implementations, the (synchronous) timing for data retransmission for synchronous communications mode may be communicated by the BS to the user device (e.g., within control information of an initial data transmission from the BS), or may be determined by the user device based on traffic type (or other parameter), e.g., based on a lookup table stored by or obtained by the user device, for example.

3) In the case where a communications mode is used (for a retransmission) that has a lower control information/CCH overhead, then this may free up or make available at least some control information/CCH resources that may be used for another purpose. According to an example implementation, the user device may be informed for what use/purpose the freed up/available control information/CCH resources will be used for. According to an example implementation, the freed-up (or made available) resources, e.g., based on using a lower CCH overhead communications mode for a data retransmission, may be used for several different options, such as, for example: 1) to transmit more parity/code bits for the same data packet/data transmission transmitted to the user device, and thereby decrease the coding rate and, as a result, increase the likelihood of the user device being able to decode the received data; 2) to multiplex (or include within the transmission resources) new data for the same user device; or 3) to multiplex data and/or control information/CCH transmitted to another user device. The option or use for these available control information/CCH resources (e.g., what information will be communicated via these freed up/available code bits within the data may: 1) be explicitly communicated from the BS to the user device within control information/CCH of an initial transmission/initial data transmission, or 2) may be determined by the BS and user device as a default (e.g., based on lookup table known by both BS and user device), e.g., by or based on traffic type and/or aggregation level for the user device or HARQ process.

As some illustrative examples, the freed up/available CCH resources or bits may be allocated/reallocated for (by way of example): 1) for URLLC traffic type, the standardized assumption could be that the available CCH resources in the retransmission will be used by data for the same packet; 2) for eMBB/mMTC type traffic, the freed up/available CCH resources in the data retransmission will be freed up for other packets (data for another user device, or new data for the same user device). For example, for aggregation levels 4 and 8, the HARQ communications mode for the retransmission may be as an example default synchronous and non-adaptive communications mode, and for aggregation level of lower than 4, the communications mode for the retransmission may be, for example, asynchronous and adaptive). These are merely a few illustrative examples, and other examples may be used.

4) According to an example implementation, the user device may determine a communications mode to be used to receive a data retransmission, e.g., based on a default or lookup table (e.g., based on traffic type and/or aggregation level), or where the communications mode for the data retransmission may be explicitly signaled by the BS to the user device via control information/CCH in an initial transmission of the HARQ process (e.g., providing an indication of a HARQ communications mode to be used by the user device to receive a data retransmission for the HARQ process). Once the user device determines a HARQ communications mode to be used to receive a data retransmission for the HARQ process (e.g., either by default or lookup table, or by receiving explicit signaling provided by the BS in control information/CCH of an initial transmission), the user device may receive the data retransmission using or based on the indicated HARQ communications mode for the data retransmission. The user device may also determine (e.g., based on a default or lookup table, or based on explicit signaling provided in the control information/CCH in the initial transmission for the HARQ process) what the freed up/available control information/CCH resources (or PRBs or bits) will be used for in the retransmission. If the available CCH resources will be used to transmit code bits for the current retransmitted data, or if the available CCH resources will be used to transmit new data for the user device, then the user device may receive this data. Otherwise, for example, if the available CCH resources of the data retransmission will be used to send data or control information/CCH to another (a different) user device, then this user device may ignore these freed up/available CCH resources (no need to receive or decode such information if these CCH resources will be used to transmit CCH or data to other user device).

According to an example implementation, a HARQ communications mode may be switched between HARQ processes. For example, CCH of an initial transmission (or a lookup table may be used) of a first HARQ process may indicate a first HARQ communications mode to be used by a user device to receive a retransmission. Likewise, a CCH of an initial transmission of a second HARQ process (or a lookup table) may indicate to the user device a second HARQ communications mode to be used to receive a retransmission for a second HARQ process of the user device. In such case, the user device may use the first HARQ communications mode to receive a retransmission for the first HARQ process. And, for example, the user device may then switch from the first HARQ communications mode to the second communications mode to receive a retransmission for the second HARQ process. In this manner, a user device may switch HARQ communications modes for different HARQ processes.

In addition, according to another example implementation, a user device may also switch (or change) HARQ communication modes during (or within) a HARQ process. For example, a CCH of an initial transmission of a HARQ process may indicate a first HARQ communications mode to be used for receiving a retransmission for the HARQ process. For example, the user device may receive a first retransmission of the HARQ process based on the first HARQ communications mode, where a CCH of the first retransmission may indicate a change to a second HARQ communications mode (e.g., for receiving a subsequent retransmission). Then, the user device may receive a second retransmission based on or using the second HARQ communications mode. Therefore, according to an example implementation, CCH/control information (e.g., within a first retransmission) may indicate a different (or change in) HARQ communications mode for a HARQ process for a user device, which may trigger or cause the user device to switch HARQ communications modes for the HARQ process from the first HARQ communications mode (e.g., used to receive the first retransmission of a packet) to a second HARQ communications mode (e.g., used to receive a second and/or third retransmission of the packet).

In this manner, for example, a much more flexible resource allocation may be provided in a case where data and control information are multiplexed on a set of resources, such as in the case where different communications modes may be used for a data retransmission, where at least some of the HARQ communications modes may have different control information/CCH overhead. As a result of the different or varying control information/CCH overhead across at least some of the HARQ communications modes, some CCH resources may be freed up or made available where a lower CCH overhead communications mode is used for a data retransmission. According to an illustrative example implementation, a BS may indicate (e.g., within a control information/CCH of an initial transmission for a HARQ process) to a user device: 1) to indicate or identify one of a plurality of HARQ communications modes to be used to transmit (and receive) a data retransmission, and 2) what these freed up/available resources will be used to transmit. Also, for example, control information in the initial transmission may also be used by a BS to indicate to the user device a timing (T) for a data retransmission in the case where a synchronous HARQ communications mode is used for the data retransmission.

The user device may attempt to decode the initial transmission. If this decoding fails, then the user device may typically send a NACK to the BS, and the BS may send a retransmission (including control information and retransmitted data, where the retransmitted data may be a redundancy version of the initial data). The user device may then receive and decode the retransmitted data, and/or may combine the retransmitted data with the initial transmission of data, e.g., using soft combining, for example.

5) According to an example implementation, the BS may determine one or more of: 1) a HARQ communications mode to be used for the data retransmission, 2) what the available or freed up control information/CCH resources or bits will be used to transmit, and/or 3) (in some cases, where synchronous communications mode is used for retransmission) a timing (T) for a retransmission. Alternatively, one or more of these may be determined by the BS and user device by default, or based on a lookup based on one or more parameters, e.g., traffic type and/or aggregation level. According to an example implementation, the BS may send an initial transmission including control information/CCH and an initial transmission of data. The control information/CCH in the initial transmission may signal or indicate the HARQ communications mode for the retransmission (if a retransmission is necessary, based on receipt of an NACK from the user device), for what purpose the available or freed up CCH resources of the retransmission will be used for, and/or may indicate a timing (T) between initial transmission and a retransmission for a synchronous communications mode for the retransmission. If a NACK is received for the HARQ process by the BS, the BS will then send a retransmission (which may include control information/CCH, and retransmitted data, or at least data), e.g., where the CCH overhead of the retransmission may be less than the CCH overhead of the initial transmission, for example, where a first HARQ communications mode may be used for an initial transmission and a second HARQ communications mode (e.g., having lower CCH overhead) may be used for the retransmission. The BS may also indicate a HARQ process ID in the initial transmission and/or retransmission, e.g., where an asynchronous communications mode is used.

According to an example implementation, a flexible transmission time interval (TTI) structure for wireless (e.g., 5G or other technology) transmission may be provided to accommodate various quality of service requirements calls for a general timing flexibility on handling HARQ transmissions, e.g., transmission that may employ different HARQ communications modes. For example, an asynchronous/adaptive HARQ communications mode may be used, e.g., for user devices that may have low to medium CCH aggregation levels. Although from the point of view of efficient resource utilization, for high aggregation level user device (e.g., cell-edge UEs) it may be useful to use the synchronous and/or non-adaptive HARQ communications modes to avoid the high CCH overhead in the retransmission. Moreover, the use of a synchronous/non-adaptive HARQ communications mode will naturally decrease control information/CCH size significantly. In other words, the control information/CCH size (or CCH overhead) when a HARQ retransmission is scheduled for a cell-edge user device may typically be (for example) much smaller than the initial transmission CCH (or CCH overhead). Since the CCH is assumed to be multiplexed with data over the same resources (e.g., for 5G wireless networks or other wireless networks), various techniques are described herein to provide a more flexible approach for resource allocation and use (and/or allow a reallocation of) the freed-up CCH resources in an efficient way.

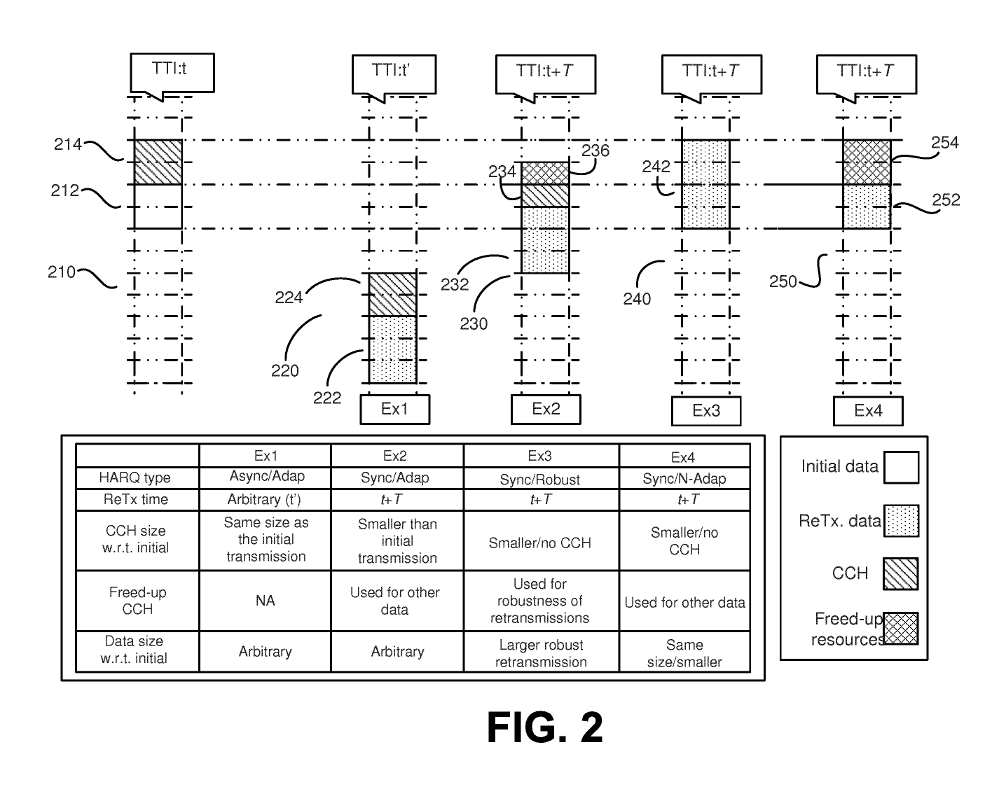

FIG. 2 is a diagram illustrating an initial transmission and a plurality of retransmissions for different communications modes according to an example implementation. As shown in FIG. 2, an initial transmission 210 from a BS to a user device is shown at time t (or at TTI or subframe=t). The initial transmission may include initial data 212 and initial control information/CCH 214. In this example, it may be assumed that the initial data 212 of the initial transmission 210 was not decoded by the receiving device (e.g., user device), and that the user device sent a NACK to the transmitting device (or BS), to cause the BS to retransmit the data (or a redundancy version of the data). FIG. 2 shows several different possible retransmissions (220, 230, 240 and 250), where each of these example retransmissions may use a different HARQ communications mode. In each transmission/retransmission shown in FIG. 2, the CCH may be, for example, time-multiplexed with the data to provide fast decoding for the receiver node. Also, the schematic presentation in FIG. 2 of in-resource CCH should not be mistaken as requiring that the CCH is frequency-multiplexed by the data. Rather, time-multiplexing may be used for data and control information/CCH. As indicated, FIG. 2 shows several possible retransmissions (retransmissions of a packet or codeword), including retransmissions 220, 230, 240 and 250, where each of the retransmissions shown, by way of example, may use a different HARQ communications mode.

For example, at example 1, an example retransmission 220 is shown for asynchronous and adaptive HARQ communications mode that includes a retransmitted data 222 and control information/CCH 224, which may be transmitted at an arbitrary time (t′), where the CCH for retransmission 220 may be the same size as the CCH 214 as the original transmission, and the retransmitted data 222 may be a different size than the originally transmitted data 212, for example. Thus, in the example 1 (asynchronous/adaptive HARQ communications mode), there are no CCH/control information resources that are freed up for other purposes.

At example 2 of FIG. 2, an example retransmission 230 is shown for a synchronous and adaptive HARQ communications mode, where the retransmission 230 is transmitted at time (or TTI)=(t=T), where T is a timing or TTI/subframe offset for the retransmission 230 with respect to the original transmission. Retransmission 230 may include retransmitted data 232 (which may use the same or different amount of resources as compared to initial transmitted data 212, due to the adaptive communications mode) and which is transmitted at time/subframe=t+T (due to synchronous communications mode, the timing or offset of T subframes/TTIs is used for the retransmission 230, as compared to the initial transmission 210). Also, as shown in FIG. 2, the retransmission 230 may include freed up (or available) resources 236, which were freed up or made available (as compared to the original transmission 210 or as compared to a retransmission that may use a CCH overhead communications mode) based on the retransmission 230 being a (type of) synchronous HARQ communications mode. Thus, by virtue of using a lower CCH overhead communications mode (e.g., synchronous communications mode), freed up resources 236 may be allocated for other purposes, or to transmit other information.

At example 3 of FIG. 2, an example retransmission 240 is shown for a synchronous and robust HARQ communications mode, where the retransmission 240 is transmitted at time (or TTI)=(t=T), where T is a timing or TTI/subframe offset for the retransmission 240 with respect to the original transmission. Retransmission 240 may include retransmitted data 242 (which may use the same amount of resources as compared to initial transmission 210). While some resources are freed up within retransmission 240 (by virtue of using a synchronous communications mode), these freed up/available resources are used to transmit additional code bit or parity bits for the retransmitted data, which may decrease the code rate and increase the probability that the user device will be able to decode the retransmitted data 242. The retransmission 240, using synchronous/robust communications mode may include less CCH or no CCH/control information, for example, although any retransmitted packet may typically include some type of control information, such as address information and other control fields, for example. Thus, the retransmission may typically include less control information/CCH due to a lower CCH overhead, and the freed up resources (based on lower CCH overhead) are used to transmit code bits or parity bits for the retransmitted data, so as to make the retransmission more robust.

At example 4 of FIG. 2, an example retransmission 250 is shown for a synchronous and non-adaptive HARQ communications mode, where the retransmission 250 is transmitted at time (or TTI)=(t=T), where T is a timing or TTI/subframe offset for the retransmission 250 with respect to the original transmission, due to being synchronous. Due to being non-adaptive, the transmission 250 does not need to transmit the HARQ process ID, and possibly other control information, for example. Retransmission 250 may include retransmitted data 252 (which may use the same or a smaller amount of resources as compared to initial transmitted data 212, due to the synchronous and adaptive communications mode, which is lower CCH overhead, as compared to the initial communications mode and/or other communications mode that may be used). Therefore, the retransmission 250 may include freed up (or available) resources 254, which were freed up or made available (as compared to the original transmission 210 or as compared to a retransmission that may use a higher CCH overhead communications mode) based on the retransmission 250 being a (type of) synchronous and non-adaptive HARQ communications mode. Thus, by virtue of using a lower CCH overhead communications mode, freed up resources 254 may be allocated for other purposes, or to transmit other information.

At the BS, the BS may determine or decide a HARQ communications mode to be used for a retransmission of a packet. In an illustrative example implementation, the HARQ communications mode to be used to receive a retransmission for a HARQ process may be indicated via table look-up or explicitly signaled or indicated by the BS to the user device via control information/CCH provided in the initial transmission from the BS to the user device. As noted above, according to an example implementation, at least in some cases, the HARQ communications mode may also change within or during a HARQ process. This choice of HARQ communications mode for a retransmission may be standardized to a default choice based on traffic type and/or aggregation level of a user device or HARQ process, or could be left up to the BS to decide based on the traffic type and/or aggregation level, etc. The CCH/control information 214 of the initial transmission 210 may be modified or configured to notify the user device of the HARQ communications mode to be used for a retransmission of the initial data for the HARQ process, and to notify the user device of what purpose or of what type of information will be transmitted in any freed up CCH resources, for example, in the event that there is a NACK and there is a retransmission.

As shown in FIG. 2, along with the Asynchronous/Adaptive HARQ communications mode (Ex. 1) that may, for example, be used for low aggregation levels, other HARQ communications modes may be used based on, for example, traffic type and/or aggregation levels. For the case of latency critical data, e.g. URLLC (ultra-reliable low latency communications) traffic type, a more robust retransmission may be used in the retransmission by using the freed-up CCH resources to reduce transmission rate and increase decoding probability, e.g., based on using a synchronous and robust communications mode (Ex. 3). This synchronous and robust communications mode may be categorized as a type of synchronous and non-adaptive communications mode. For example, the timing of the retransmission 240 (synchronous and robust) is synchronous and the transmission attributes are non-adaptive, however the number of transmitted coded bits (or code bits) may increase with respect to the initial transmission 210. Ex. 4 in FIG. 2 corresponds to the synchronous/non-adaptive communications mode and the freed-up CCH resources can be used for transmission of other data. Thus, for example, for a synchronous/robust communications mode, the same frequency resources and all or nearly all transmission attribute may be the same in the retransmission as the initial transmission. However, in an example implementation of synchronous/robust communications mode, the coding rate may change. In Ex. 3 of FIG. 2, a synchronous/robust communications mode may be used for a retransmission 240, where a number of transmitted code bits (coded bits) may be increased, and may thereby decrease the code rate and increase the likelihood that the user device/receiver will be able to decode the received data, for example. As noted, the control information/CCH 214 of the initial transmission may indicate the HARQ communications mode for a retransmission, as well as may indicate a purpose of any freed up resources or a type of information that will be transmitted for any freed up or available CCH resources.

At the user device, the user device will receive the control information/CCH 214 and attempt to decode the data 212 of the initial transmission 210. The control information/CCH 214 of the initial transmission 210 may indicate the HARQ communications mode to be used to receive any retransmission of the data for the (same) HARQ process. In case of decoding failure (of the initial data 212) and NACK feedback from the user device, the user device will automatically switch to the appropriate HARQ communications mode for the retransmission of the same HARQ process.

Also, for example, the in-resource CCH may be multiplexed with the data and have, for example, at most the same bandwidth as the allocated resources. In order to be able to free up the CCH resources in the retransmission and use the freed-up resources, e.g., for transmission of other data, the placement or location of the CCH/control information in the allocated resources in the initial transmission may be selected to be in a contiguous area or chunk of resources that may be removed or decreased, or re-allocated together as a whole. In other words, a “clean-cut” or complete removal (e.g., as a single chunk of resources) of the CCH out of the allocated resources may (or should) be possible.

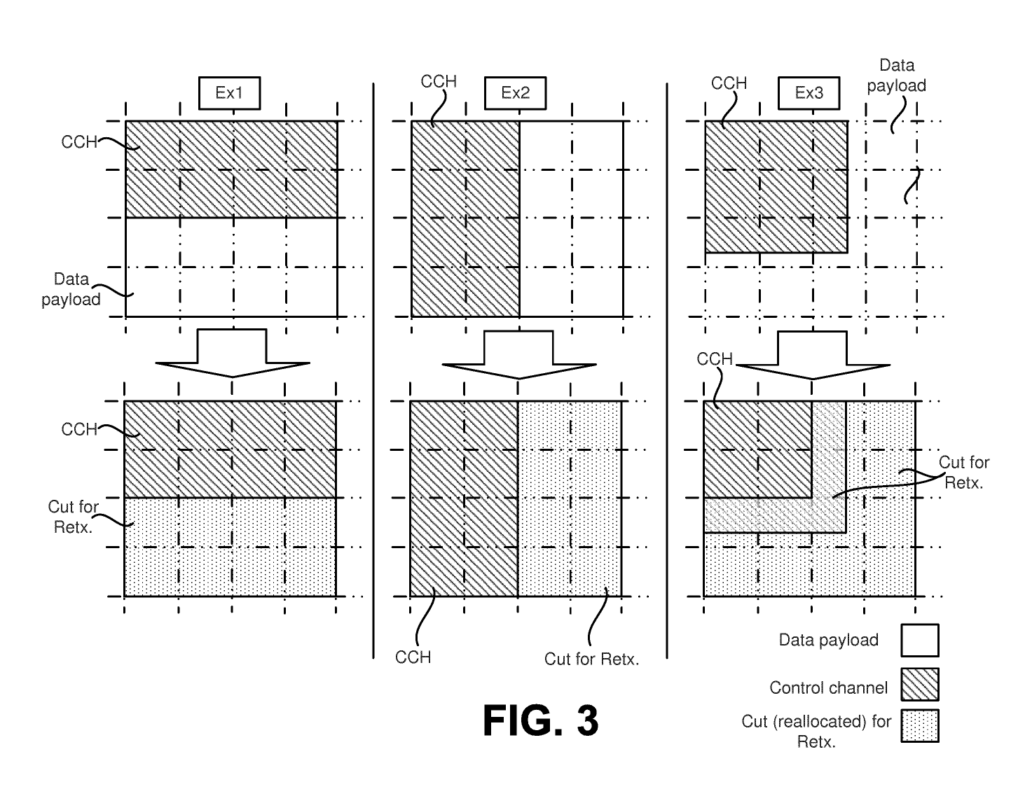

FIG. 3 is a diagram illustrating a re-allocation of control information/CCH resources for a retransmission according to example implementations. FIG. 3 illustrates different examples of how the CCH may be multiplexed in the allocated resources.

For the cases relevant to the context of this invention (high aggregation levels) the CCH takes up multiple short TTI resource blocks (RBs) of 2×12 resource elements (REs); e.g. according to Table 1, the aggregation level of 8 needs 12 short TTI RBs for CCH while 6 short TTI RBs are needed for the CCH with aggregation level 4. This naturally implies that a clean-cut CCH placement is possible as long as the CCH is multiplexed by the data in the RB level, e.g. in FIG. 3 for Ex. 1 and Ex. 2 (and not in the OFDM symbol or subcarrier level as in Ex. 3 of FIG. 3). Although, this can be considered in the standard to make sure that a clean-cut CCH placement always happens for relevant cases, one can still consider an arbitrary robustness-increasing cut as in Ex. 3 of FIG. 3.

It should be noted again that it may be most efficient to multiplex CCH and data in the time domain (e.g., as shown in Ex. 2 in FIG. 3), which will help the timing of the decoding process at the user device/UE. Therefore, for a time-multiplexed CCH with data, Synchronous/Non-Adaptive retransmission of the HARQ process will happen in a shorter TTI compared to the initial transmission while the freed-up CCH resources will be used by the BS for transmission of other packets. A Synchronous HARQ retransmission on the other hand, takes place in the same TTI length as in the initial transmission.

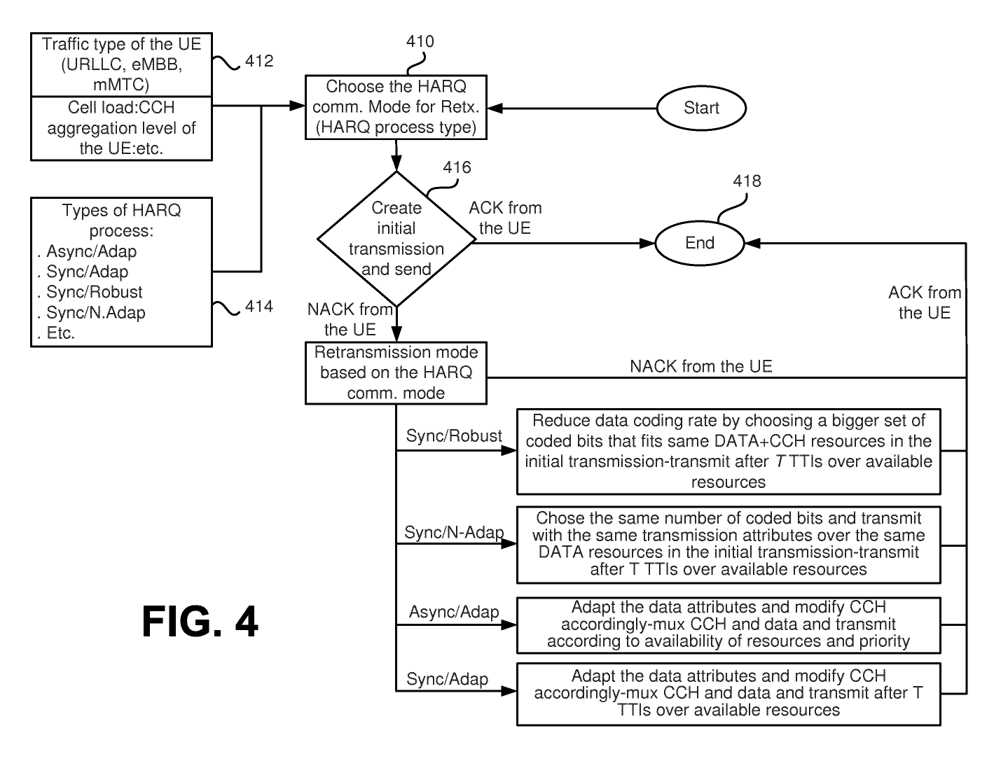

FIG. 4 is a flow chart illustrating operation of a base station according to an example implementation. At 410, the BS (eNB) may select or determine or choose a HARQ communications mode (or HARQ process type) to be use for any required retransmission for a HARQ process. As shown at 412, the BS may select or determine the HARQ communications mode for a retransmission for a HARQ process based on, for example, a cell load, a CCH aggregation level for the user device/UE, and/or a traffic type of the user device/UE (such as, e.g., URLLC—ultra-reliable low latency communication, eMBB—enhanced mobile broadband, mMTC—massive machine-type communication, . . . ).

As shown at 414, the BS may select a HARQ communications mode (or HARQ process type) out of a plurality of possible HARQ communications modes, such as, for example: asynchronous/adaptive (e.g., having a highest CCH overhead for a retransmission, as compared to other HARQ communications modes), synchronous/adaptive, synchronous/robust, synchronous/non-adaptive (e.g., which, as an illustrative example, may have the lowest CCH overhead, or may have a lower CCH overhead as compared to asynchronous/adaptive, where the freed up CCH resources in the retransmission for synchronous/non-adaptive may be allocated to transmit other information or for other purposes). These are merely a few illustrative examples of HARQ communications modes, where different amount of CCH overhead may be used or provided for retransmissions of different HARQ communications modes, thereby freeing up (for reallocation) different amounts of control information/CCH resources, which may be reallocated for other purposes/to transmit other information.

At 416, the BS may generate (or create) an initial transmission (e.g., include initial data and control information/CCH). The control information of the initial transmission may, for example, indicate/identify the HARQ communications mode to be used for a retransmission (if necessary), and may also indicate/identify what any freed up CCH resources may be allocated for or used for in the retransmission. If an ACK is received by the BS from the user device/UE, then the process ends at 418. On the other hand, if a NACK is received for the initial transmission, then the BS will send a retransmission according to the selected HARQ communications mode (or HARQ process type) to be used for retransmission.

Thus, for example, for a synchronous/robust communications mode, the data coding rate may be reduced by choosing or providing a larger set of coded bits that may fit in the same data+CCH resources of the initial transmission. This is because, for example, at least some of the CCH resources are reallocated to transmit additional code bits for the retransmitted data for the synchronous/robust communications mode. For a synchronous/non-adaptive communications mode, a same number of coded bits as the initial transmission are selected or provided, and the retransmission is transmitted a fixed time (T) or fixed number (T) of TTIs/subframes after the initial transmission. Also, for example, an asynchronous/adaptive communications mode may adapt one or more data (or transmission) attributes and may modify the CCH accordingly, and may multiplex the CCH and data and transmit according to availability of resources and priority. Also, a synchronous/adaptive communications mode may adapt the data attribute(s) and modify the CCH accordingly, and may multiplex the CCH and data and transmit the retransmission after T TTIs/subframes (from the initial transmission) over available resources.

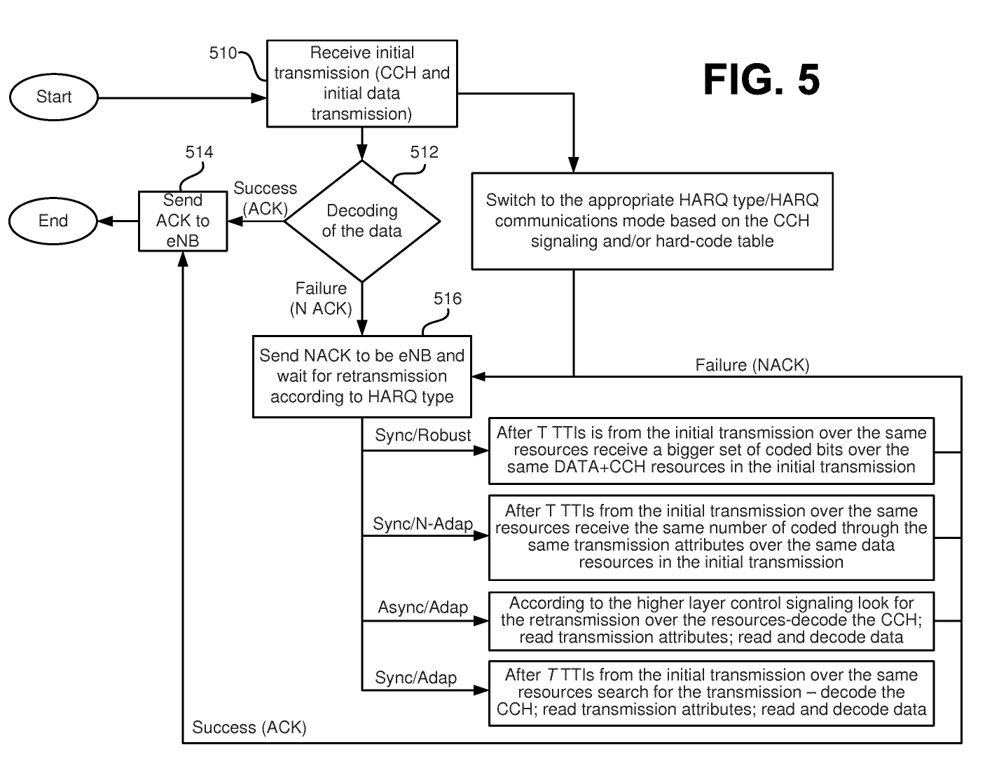

FIG. 5 is a flow chart illustrating operation of a user device (UE) according to an example implementation. At 510, the user device (or UE) receives the control information/CCH and initial data of the initial transmission. At 512, the user device attempts to decode the initial data. If decoding the initial data is successful, then at 514, the user device sends an ACK for the initial transmission to the BS. If the decoding at 512 is unsuccessful/fails, then the user device (or UE) sends a NACK (or decoding failure indication) to the BS at 516, and the user device waits for the retransmission of the data. The user device then uses the HARQ communications mode to be used for the retransmission to receive the retransmission (including any CCH/control information and retransmitted data). The HARQ communications mode to be used (or that will be used) for retransmission may be indicated by a table/look-up table or other reference or stored information, or may be explicitly indicated by the BS to the user device in the CCH of the initial transmission, for example. Also, according to another example implementation, a change in a HARQ communications mode for a HARQ process may also be indicated by the BS via CCH of a retransmission, e.g., which may cause the user device to switch HARQ communication modes, such as from a first HARQ communications mode (e.g., which was/may have been used by the user device to receive a first retransmission for the HARQ process) to a second HARQ communications mode (e.g., to receive a second retransmission).

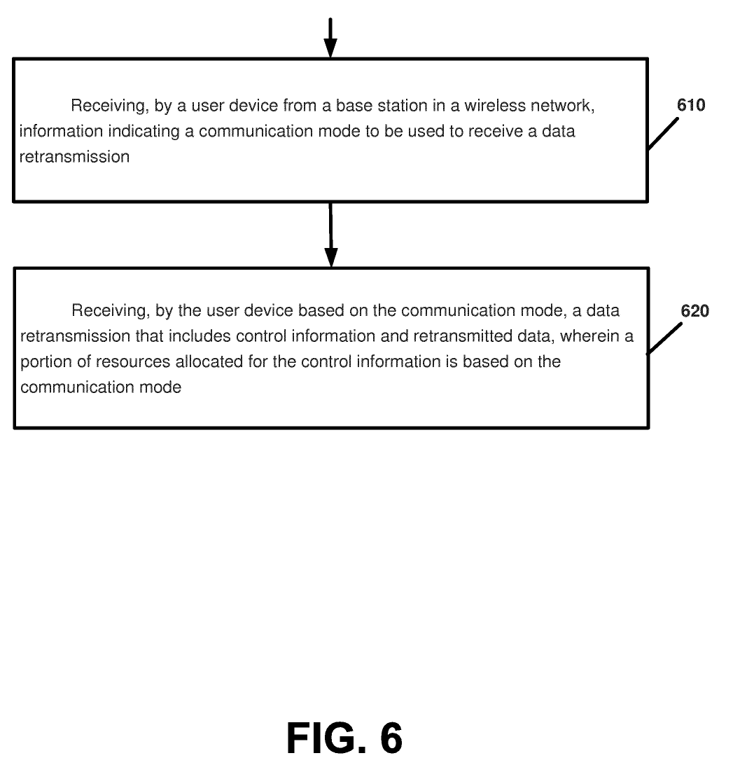

FIG. 6 is a flow chart illustrating operation of a user device according to an example implementation. Operation 610 may include receiving, by a user device from a base station in a wireless network, information indicating a communications mode to be used to receive a data retransmission. Operation 620 may include receiving, by the user device based on the communications mode, a data retransmission that includes control information and retransmitted data, wherein a portion of resources allocated for the control information is based on the communications mode.

According to an example implementation of the method of FIG. 6, wherein the receiving information indicating a communications mode may include: receiving, by a user device from the base station, an initial transmission including a first control information and an initial transmission of data, the first control information indicating a communications mode to be used to receive a retransmission of the data, wherein a control information overhead of the second communications mode is less than a control information overhead of the initial transmission.

According to an example implementation of the method of FIG. 6, the receiving a data retransmission may include: receiving, by the user device using the communications mode, a data retransmission that includes a second control information and retransmitted data that are multiplexed on a set of resources, wherein a portion of the set of resources allocated for the second control information is based on the communications mode.

According to an example implementation of the method of FIG. 6, the method further including: failing, by the user device, to decode the initial transmission of data; sending, by the user device to the base station, a negative acknowledgement (NACK) for the initial transmission of data; wherein the receiving a data retransmission comprises receiving, by the user device using the communications mode, a data retransmission that includes a second control information and the retransmitted data that are multiplexed on a set of resources, wherein a portion of the set of resources allocated for the second control information is based on the communications mode.

According to an example implementation of the method of FIG. 6, wherein a communications mode may include one or more of the following hybrid automatic repeat request (HARQ) communications modes: an asynchronous HARQ communications mode; a synchronous HARQ communications mode; an adaptive HARQ communications mode; a non-adaptive HARQ communications mode; a synchronous and non-Adaptive HARQ communications mode; an asynchronous and adaptive HARQ communications mode; and a synchronous and robust HARQ communications mode.

According to an example implementation of the method of FIG. 6, the communications mode to receive the data retransmission may include a synchronous hybrid automatic repeat request (HARQ) communications mode in which the data retransmission is received at a fixed offset from the initial transmission of the data, wherein the first control information indicates the fixed offset for receiving the data retransmission.

According to an example implementation of the method of FIG. 6, the communications mode to receive the data retransmission is a synchronous HARQ communications mode in which the data retransmission is at a fixed offset in time from the initial transmission of the data, wherein a control information overhead of the retransmission that uses the synchronous HARQ communications mode is less than a control information overhead of the initial transmission.

According to an example implementation of the method of FIG. 6, the fixed offset is based on a traffic type for the retransmitted data.

According to an example implementation of the method of FIG. 6, wherein, based on a lower control information overhead for the data retransmission that uses the communications mode as compared to the control information overhead of the initial transmission, a portion of control information resources for the data retransmission is available to be re-allocated to transmit other information, the method further including: receiving, by the user device from the base station via the first control information, an indication of a type of information that will be transmitted by the base station via the available control information resources of the data retransmission.

According to an example implementation of the method of FIG. 6, the indication of a type of information that will be transmitted by the base station via the available control information resources of the data retransmission may include one or more of the following: an indication that additional code bits or parity bits for the retransmitted data will be transmitted to the user device via the available control information resources of the data retransmission, to thereby reduce a code rate for the retransmitted data; an indication that additional data, as a new initial data transmission, will be transmitted to the user device via the available control information resources of the data retransmission; and an indication that control information or data will be transmitted to another user device via the available control information resources of the data retransmission.

According to an example implementation, an apparatus may include at least one processor and at least one memory including computer instructions, when executed by the at least one processor, cause the apparatus to: receive, by a user device from a base station in a wireless network, information indicating a communications mode to be used to receive a data retransmission; and receive, by the user device based on the communications mode, a data retransmission that includes control information and retransmitted data, wherein a portion of resources allocated for the control information is based on the communications mode.

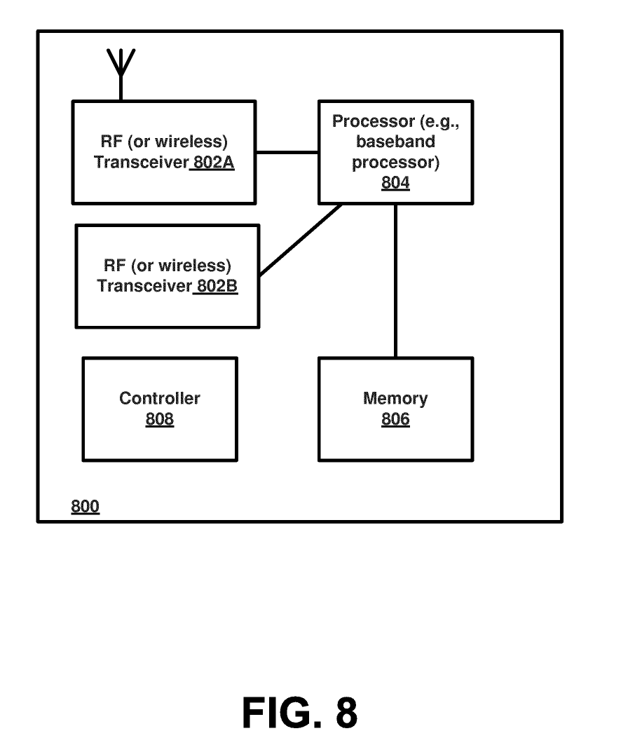

According to an example implementation, an apparatus may include means (e.g., 802A/802B and/or 804, FIG. 8) for receiving, by a user device from a base station in a wireless network, information indicating a communications mode to be used to receive a data retransmission; and means (e.g., 802A/802B and/or 804, FIG. 8) for receiving, by the user device based on the communications mode, a data retransmission that includes control information and retransmitted data, wherein a portion of resources allocated for the control information is based on the communications mode.

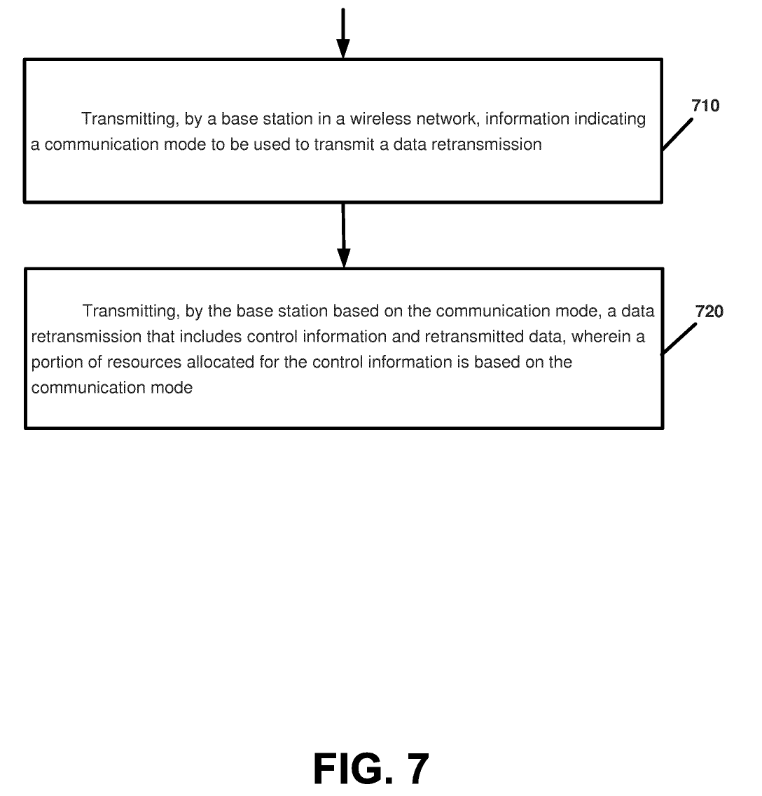

FIG. 7 is a flow chart illustrating operation of a base station according to an example implementation. Operation 710 may include transmitting, by a base station in a wireless network, information indicating a communications mode to be used to transmit a data retransmission. Operation 820 may include transmitting, by the base station based on the communications mode, a data retransmission that includes control information and retransmitted data, wherein a portion of resources allocated for the control information is based on the communications mode.

According to an example implementation of the method of FIG. 7, the transmitting information indicating a communications mode may include: transmitting, by a base station using the first communications mode, an initial transmission including a first control information and an initial transmission of data, the first control information indicating a second communications mode to be used to transmit a retransmission of the data, wherein a control information overhead of the second communications mode is less than a control information overhead of the initial transmission.

According to an example implementation of the method of FIG. 7, the transmitting a data retransmission may include: transmitting, by the base station using the second communications mode, a data retransmission that includes a second control information and retransmitted data that are multiplexed on a set of resources, wherein a portion of the set of resources allocated for the second control information is based on the communications mode.

According to an example implementation of the method of FIG. 7, a communications mode may include one or more of the following hybrid automatic repeat request (HARQ) communications modes: an asynchronous HARQ communications mode; a synchronous HARQ communications mode; an adaptive HARQ communications mode; a non-adaptive HARQ communications mode; a synchronous and non-Adaptive HARQ communications mode; an asynchronous and adaptive HARQ communications mode; and a synchronous and robust HARQ communications mode.

According to an example implementation of the method of FIG. 7, the communications mode to transmit the data retransmission may include a synchronous hybrid automatic repeat request (HARQ) communications mode in which the data retransmission is transmitted at a fixed offset from the initial transmission of the data, wherein the first control information indicates the fixed offset for transmitting the data retransmission.

According to an example implementation of the method of FIG. 7, the HARQ communications mode to transmit the data retransmission is a synchronous HARQ communications mode in which the data retransmission is at a fixed offset in time from the initial transmission of the data.

According to an example implementation of the method of FIG. 7, the fixed offset is based on a traffic type for the retransmitted data.

According to an example implementation of the method of FIG. 7, wherein, based on a lower control information overhead for the data retransmission that uses the communications mode as compared to a control information overhead of the initial transmission, a portion of control information resources for the data retransmission is available to be re-allocated to transmit other information, the method further including: transmitting, by the base station via the first control information, an indication of a type of information that will be transmitted by the base station via the available control information resources of the data retransmission.

According to an example implementation of the method of FIG. 7, the indication of a type of information that will be transmitted by the base station via the available control information resources of the data retransmission includes one or more of the following: an indication that additional code bits or parity bits for the retransmitted data will be transmitted to the user device via the available control information resources of the data retransmission, to thereby reduce a code rate for the retransmitted data; an indication that additional data, as a new initial data transmission, will be transmitted to the user device via the available control information resources of the data retransmission; and; an indication that control information or data will be transmitted to another user device via the available control information resources of the data retransmission.

According to an example implementation, an apparatus may include at least one processor and at least one memory including computer instructions, when executed by the at least one processor, cause the apparatus to: transmit, by a base station in a wireless network, information indicating a communications mode to be used to transmit a data retransmission; and transmit, by the base station based on the communications mode, a data retransmission that includes control information and retransmitted data, wherein a portion of resources allocated for the control information is based on the communications mode.

According to an example implementation, an apparatus may include means (e.g., 802A/802B, and/or 804, FIG. 8) for transmitting, by a base station in a wireless network, information indicating a communications mode to be used to transmit a data retransmission; and means (e.g., 802A/802B, and/or 804, FIG. 8) for transmitting, by the base station based on the communications mode, a data retransmission that includes control information and retransmitted data, wherein a portion of resources allocated for the control information is based on the communications mode.

FIG. 8 is a block diagram of a wireless station (e.g., AP or user device) 800 according to an example implementation. The wireless station 800 may include, for example, one or two RF (radio frequency) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 304, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
receiving, by a user device from a base station in a wireless network, information indicating a communications mode to be used to receive a data retransmission; and
receiving, by the user device based on the communications mode, a data retransmission that includes control information and retransmitted data, wherein a portion of resources allocated for the control information is based on the communications mode.

2. A method of claim 1 wherein the receiving information indicating a communications mode comprises:
receiving, by a user device from the base station, an initial transmission including a first control information and an initial transmission of data, the first control information indicating a communications mode to be used to receive a retransmission of the data, wherein a control information overhead of the second communications mode is less than a control information overhead of the initial transmission.

3. The method of claim 2 wherein the receiving a data retransmission comprises:
receiving, by the user device using the communications mode, a data retransmission that includes a second control information and retransmitted data that are multiplexed on a set of resources, wherein a portion of the set of resources allocated for the second control information is based on the communications mode.

4. The method of claim 2, and further comprising:
failing, by the user device, to decode the initial transmission of data;
sending, by the user device to the base station, a negative acknowledgement (NACK) for the initial transmission of data;
wherein the receiving a data retransmission comprises receiving, by the user device using the communications mode, a data retransmission that includes a second control information and the retransmitted data that are multiplexed on a set of resources, wherein a portion of the set of resources allocated for the second control information is based on the communications mode.

5. The method of claim 1 wherein a communications mode comprises one or more of the following hybrid automatic repeat request (HARQ) communications modes:
an asynchronous HARQ communications mode;
a synchronous HARQ communications mode;
an adaptive HARQ communications mode;
a non-adaptive HARQ communications mode;
a synchronous and non-Adaptive HARQ communications mode;
an asynchronous and adaptive HARQ communications mode; and
a synchronous and robust HARQ communications mode.

6. The method of claim 2 wherein the communications mode to receive the data retransmission comprises a synchronous hybrid automatic repeat request (HARQ) communications mode in which the data retransmission is received at a fixed offset from the initial transmission of the data, wherein the first control information indicates the fixed offset for receiving the data retransmission.

7. The method of claim 2 wherein the communications mode to receive the data retransmission is a synchronous HARQ communications mode in which the data retransmission is at a fixed offset in time from the initial transmission of the data, wherein a control information overhead of the retransmission that uses the synchronous HARQ communications mode is less than a control information overhead of the initial transmission.

8. (canceled)

9. The method of claim 2 wherein, based on a lower control information overhead for the data retransmission that uses the communications mode as compared to the control information overhead of the initial transmission, a portion of control information resources for the data retransmission are available to be re-allocated to transmit other information, the method further comprising:
receiving, by the user device from the base station via the first control information, an indication of a type of information that will be transmitted by the base station via the available control information resources of the data retransmission.

10. The method of claim 9 wherein the indication of a type of information that will be transmitted by the base station via the available control information resources of the data retransmission comprises one or more of the following:
an indication that additional code bits or parity bits for the retransmitted data will be transmitted to the user device via the available control information resources of the data retransmission, to thereby reduce a code rate for the retransmitted data;
an indication that additional data, as a new initial data transmission, will be transmitted to the user device via the available control information resources of the data retransmission; and
an indication that control information or data will be transmitted to another user device via the available control information resources of the data retransmission.

11. (canceled)

12. A computer program product for a computer, comprising software code portions for performing the steps of claim 1 when said product is run on the computer.

13. An apparatus comprising at least one processor and at least one memory including computer instructions, when executed by the at least one processor, cause the apparatus to:
receive, by a user device from a base station in a wireless network, information indicating a communications mode to be used to receive a data retransmission; and
receive, by the user device based on the communications mode, a data retransmission that includes control information and retransmitted data, wherein a portion of resources allocated for the control information is based on the communications mode.

14. A method comprising:
transmitting, by a base station in a wireless network, information indicating a communications mode to be used to transmit a data retransmission; and
transmitting, by the base station based on the communications mode, a data retransmission that includes control information and retransmitted data, wherein a portion of resources allocated for the control information is based on the communications mode.

15. The method of claim 14 wherein the transmitting information indicating a communications mode comprises:
transmitting, by a base station using the first communications mode, an initial transmission including a first control information and an initial transmission of data, the first control information indicating a second communications mode to be used to transmit a retransmission of the data, wherein a control information overhead of the second communications mode is less than a control information overhead of the initial transmission.

16. The method of claim 15 wherein the transmitting a data retransmission comprises:
transmitting, by the base station using the second communications mode, a data retransmission that includes a second control information and retransmitted data that are multiplexed on a set of resources, wherein a portion of the set of resources allocated for the second control information is based on the communications mode.

17. The method of claim 14 wherein a communications mode comprises one or more of the following hybrid automatic repeat request (HARQ) communications modes:
an asynchronous HARQ communications mode;
a synchronous HARQ communications mode;
an adaptive HARQ communications mode;
a non-adaptive HARQ communications mode;
a synchronous and non-Adaptive HARQ communications mode;
an asynchronous and adaptive HARQ communications mode; and
a synchronous and robust HARQ communications mode.

18. The method of claim 15 wherein the communications mode to transmit the data retransmission comprises a synchronous hybrid automatic repeat request (HARQ) communications mode in which the data retransmission is transmitted at a fixed offset from the initial transmission of the data, wherein the first control information indicates the fixed offset for transmitting the data retransmission.

19. The method of claim 15 wherein the HARQ communications mode to transmit the data retransmission is a synchronous HARQ communications mode in which the data retransmission is at a fixed offset in time from the initial transmission of the data.

20. (canceled)

21. The method of claim 15 wherein, based on a lower control information overhead for the data retransmission that uses the communications mode as compared to a control information overhead of the initial transmission, a portion of control information resources for the data retransmission are available to be re-allocated to transmit other information, the method further comprising:
transmitting, by the base station via the first control information, an indication of a type of information that will be transmitted by the base station via the available control information resources of the data retransmission.

22. The method of claim 21 wherein the indication of a type of information that will be transmitted by the base station via the available control information resources of the data retransmission comprises one or more of the following:
an indication that additional code bits or parity bits for the retransmitted data will be transmitted to the user device via the available control information resources of the data retransmission, to thereby reduce a code rate for the retransmitted data;
an indication that additional data, as a new initial data transmission, will be transmitted to the user device via the available control information resources of the data retransmission; and
an indication that control information or data will be transmitted to another user device via the available control information resources of the data retransmission.

23. (canceled)

24. A computer program product for a computer, comprising software code portions for performing the steps claim 14 when said product is run on the computer.

25. (canceled)
